(19) United States
(12) Patent Application Publication
(10) Pub. No.: US 2013/0262791 A1
(43) Pub. Date: Oct. 3, 2013

(54) HOST-SIDE SUPPORT OF DYNAMICALLY CHANGING FREQUENCY IN MEMORY SYSTEMS

(71) Applicants: Joab D. Henderson, Pflugerville, TX (US); Ryan J. Pennington, Austin, TX (US); Anuwat Saetow, Austin, TX (US); Robert B. Tremaine, Stormville, NY (US); Kenneth L. Wright, Austin, TX (US)

(72) Inventors: Joab D. Henderson, Pflugerville, TX (US); Ryan J. Pennington, Austin, TX (US); Anuwat Saetow, Austin, TX (US); Robert B. Tremaine, Stormville, NY (US); Kenneth L. Wright, Austin, TX (US)

(73) Assignee: INTERNATIONAL BUSINESS MACHINES CORPORATION, Armonk, NY (US)

(21) Appl. No.: 13/430,807

(22) Filed: Mar. 27, 2012

(51) Int. Cl. G06F 12/00

(52) U.S. Cl. 711/154; 711/E12.001

(57) ABSTRACT

An embodiment is a method for operating a memory system, the method including storing initial calibration values for each of a first frequency and second frequency for a memory device, performing a periodic calibration to determine a calibration update value for operation of the memory device at the first frequency, combining the calibration update value with the initial calibration value for the first frequency to provide an updated calibration for operation of the memory device at an operating frequency of the first frequency and receiving a frequency change request at a memory controller associated with the memory device. The method further includes blocking traffic to the memory device, adjusting operating frequency to the second frequency while the memory device remains powered, combining the calibration update value with the initial calibration value for the second frequency for operation at the second frequency and enabling traffic to the memory device.

### BACKGROUND

The present invention relates to memory systems, and more specifically, to host-side support of dynamically changing frequency in memory systems.

Overall computer system performance and power consumption is affected by each of the key elements of the structure of the computer system, including the performance of the processor(s), any memory cache(s), the input/output (I/O) subsystem(s), the efficiency of the memory control function(s), the main memory device(s), and the type and structure of the memory interconnect interface(s).

Power balancing and conservation is an important task for modern computer systems, such as servers, as systems become more complex and consume more resources. For example, servers use frequency scaling on their processors in order to facilitate power balancing. Specifically, in cases where the processor is determined as being underutilized, the processor frequency can be reduced, lowering power consumption of the processor.

As server systems grow in complexity, the amount of memory included in systems has increased significantly. Accordingly, reducing power consumption by the memory may also provide significant power savings for server systems. In some cases, changing the frequency of memory subsystems include powering down and rebooting the memory system, which would require traffic and communication to the memory device to stop for a long period of time. Accordingly, the time that traffic is stopped for this process make it impractical as an option to conserve power in server system.

### SUMMARY

An embodiment is a method for operating a memory system, the method including storing initial calibration values for each of a first frequency and second frequency for a memory device, performing a periodic calibration to determine a calibration update value for operation of the memory device at the first frequency, combining the calibration update value with the initial calibration value for the first frequency to provide an updated calibration for operation of the memory device at an operating frequency of the first frequency and receiving a frequency change request at a memory controller associated with the memory device. The method further includes blocking traffic to the memory device, adjusting operating frequency from the first frequency to the second frequency, wherein the operating frequency is adjusted while the memory device remains powered, combining the calibration update value with the initial calibration value for the second frequency for operation at the second frequency and enabling traffic to the memory device.

Another embodiment is a system for operating a memory system that includes a memory controller and a memory device, the system configured to perform a method. The method includes storing initial calibration values for each of a first frequency and second frequency for a memory device, performing a periodic calibration to determine a calibration update value for operation of the memory device at the first frequency, combining the calibration update value with the initial calibration value for the first frequency to provide an updated calibration for operation of the memory device at an operating frequency of the first frequency, receiving a frequency change request at a memory controller associated with the memory device and blocking traffic to the memory device. The method also includes adjusting operating frequency from the first frequency to the second frequency, wherein the operating frequency is adjusted while the memory device remains powered, combining the calibration update value with the initial calibration value for the second frequency for operation at the second frequency and enabling traffic to the memory device.

A further embodiment is a computer program product for operating a memory system that includes a tangible storage medium readable by a processing circuit and storing instructions for execution by the processing circuit for performing a method. The method includes storing initial calibration values for a first frequency and second frequency for a memory device, performing a periodic calibration to determine a calibration update value for operation of the memory device at the first frequency, combining the calibration update value with the initial calibration value for the first frequency to provide an updated calibration for operation of the memory device at an operating frequency of the first frequency, receiving a frequency change request at a memory controller associated with the memory device and blocking traffic to the memory device. The method also includes adjusting operating frequency from the first frequency to the second frequency, wherein the operating frequency is adjusted while the memory device remains powered, combining the calibration update value with the initial calibration value for the second frequency for operation at the second frequency and enabling traffic to the memory device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a memory system in accordance with an embodiment;

FIG. 2 depicts block diagram of an exemplary process for managing and operating the memory system in accordance with an embodiment;

FIG. 3 is a block diagram block diagram of a process for calibrating the memory system in accordance with an embodiment; and

FIG. 4 is a block diagram of a process for calibrating the memory system in accordance with an embodiment.

### DETAILED DESCRIPTION

An embodiment is utilized to enable operating frequency changes for memory systems. In an embodiment, the memory system includes a memory controller that performs initial calibration for a plurality of operating frequencies during boot or power up of the memory system. Values from the initial calibration are then stored and the system begins operating at a first or nominal frequency. Periodic drift calibrations are then performed to adjust for non-frequency based changes from the initial calibration data. The drift calibration value is then combined with the initial calibration value for the current operating frequency (e.g., nominal frequency). Such drift calibrations adjust for small changes due to frequency, voltage or temperature over time. After receiving a frequency change request, the memory controller blocks traffic to one or more memory device in the system. In an embodiment, the frequency changes from the nominal frequency to a second frequency while remaining powered, where both frequencies are included in the plurality of initial calibration frequencies. The current drift values are then combined with the initial calibration values for the new frequency (e.g., second frequency). In an embodiment, the system performs a short or coarse calibration to verify proper calibration and then resumes operation, thereby enabling traffic flow to the memory device. By enabling a dynamic frequency change process while the memory system remains powered, the period of time to perform the frequency change is reduced as compared to systems that require a power cycle and reboot to change frequency. Thus, the method and system for frequency change enables conservation of power by the memory system while also improving efficiency and performance.

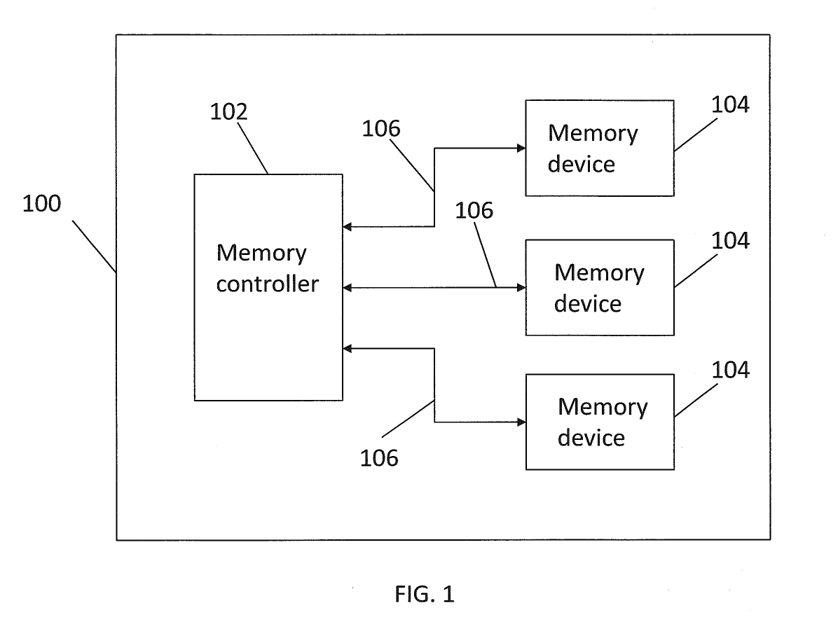

FIG. 1 depicts a block diagram of a memory system 100 in accordance with an embodiment. A memory controller 102 is in communication with a plurality of associated memory devices 104 via a plurality of memory buses 106. In one embodiment, the memory buses 106 are bi-directional. In another embodiment each memory bus 106 includes two uni-directional busses. In an embodiment, the memory buses 106 transmit clock, data, commands, and a data strobe between the memory controller 102 and the memory devices 104, wherein calibration of timing for one or more of these signals improve timing and communication accuracy for the memory system. The calibration may be particularly important when the memory device 104 operating frequency is changed.

The examples described herein are directed to memory systems having memory devices such as dynamic random access memory (DRAM) memory devices, however embodiments apply to any memory systems that include memory devices that communicate signals across a path, such as memory bus 106, where the frequency and transmission of the signals requires calibration to accurately communicate.

As used herein, the term “memory controller” refers to any device that controls access to a memory device. A memory controller may be included as part of a processor, as a stand alone processor or in a memory hub or buffer device. In an embodiment, the memory controller also controls the physical layer interface signals (e.g., via additional delay elements) to the DRAM device. In one embodiment, the memory controller includes a buffer to facilitate communication with memory devices. The memory controller and the memory device may require calibration to enable the memory device to properly read and write data. For ease of explanation, the method and system may be discussed with reference to a single memory controller, memory bus and memory device, but may also apply to systems with a plurality of memory controllers, memory buses and memory devices. Further, though some portions of the discussion may refer to a single calibration value or simply calibration data, the calibration processes may utilize plurality of values to compensate for inaccuracies.

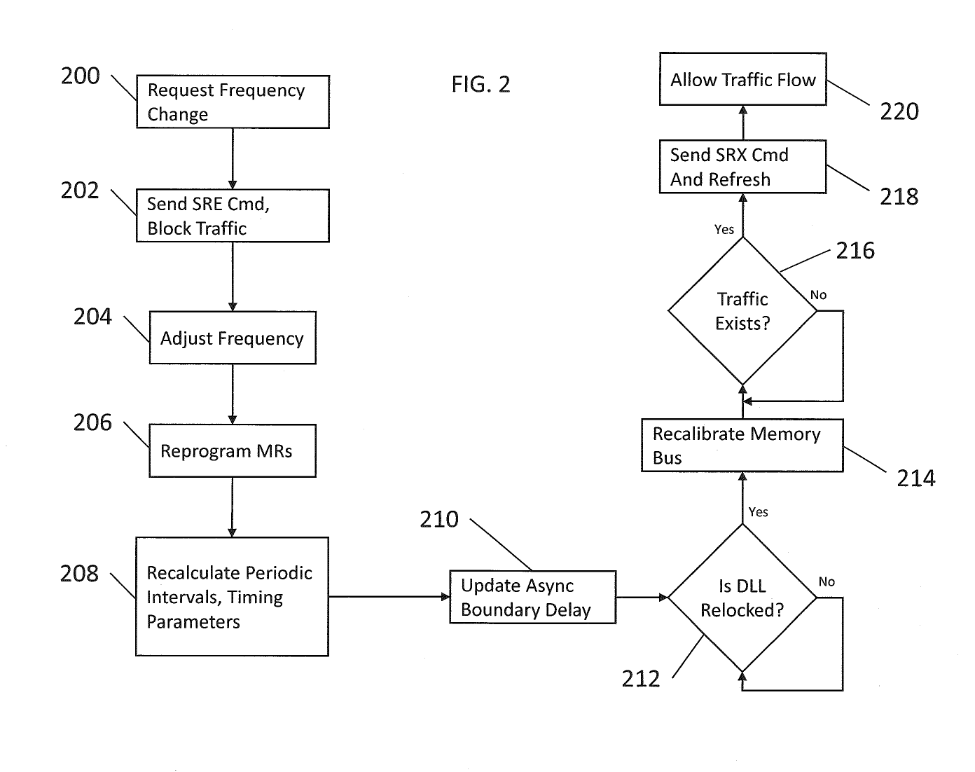

FIG. 2 is a block diagram of an exemplary process for managing and operating a memory system, such as the memory system 100 of FIG. 1 including one or more memory controller 102 and one or more memory device 104. In block 200, a request for frequency change or adjustment is received by the memory controller 102. In block 202, the memory controller 102 sends a self-timed refresh enter (SRE) command to the memory device 104. Specifically, the SRE command instructs the memory device 104 (e.g., a synchronous DRAM or “SDRAM”) to perform periodic refreshes of the device to prevent data loss during the frequency change operation. The block 202 also blocks stops traffic to the memory device 104 to ensure no data is sent during the frequency change process. Therefore, the memory device 104 is in a state that allows a frequency change and provides that the memory bus 106 will experience no interruptions during the procedure. In block 204, the frequency is adjusted to one of a plurality of operating frequencies. As discussed below, an initial calibration is performed at each of the plurality of operating frequencies during boot to provide calibration values that are used by the memory system 100 during frequency change operations.

In block 206, commands program or write mode registers (MRs) on the memory device 104 to alter frequency-dependent memory device settings to support the new operating frequency. In block 208, intervals for periodic functions and memory device timing parameters are recalculated to support the new operating frequency. In block 210, registers are updated that control asynchronous boundary crossing delays between the memory controller and interconnect bus between the cores and their cache(s). This block allows systems that run the memory asynchronous to the rest of the processor to adjust the delay between the data being returned by the memory controller and when the “next unit” (whether it is the interconnect bus, the caches or the core itself) is able to access it. In block 212, the memory system 100 checks to see if the DLL (delay-locked loop) is relocked and is stabilized at the new operating frequency. The DLL compares a local clock signal to a reference clock signal and utilizes delay gates to ensure that both are in sync. When they are in sync, the DLL is considered locked. If the DLL is not relocked, then it waits until the DLL is confirmed as relocked. In block 214, if the DLL is relocked communication to the memory device 104 through the memory bus 106 and/or other paths is recalibrated to support the new frequency. Embodiments of block 214 are described in detail below. In block 216, the memory controller 102 determines if traffic to the memory device 104 exists. If not, the controller waits for the traffic to appear before proceeding to block 218. In block 218, after it is determined that traffic exists, a self-timed refresh exit (SRX) command is sent to the memory device 104. Further, a refresh of the memory device 104 is performed to maintain memory cell data retention. In block 220, the memory controller 102 enables traffic flow to the memory device 104.

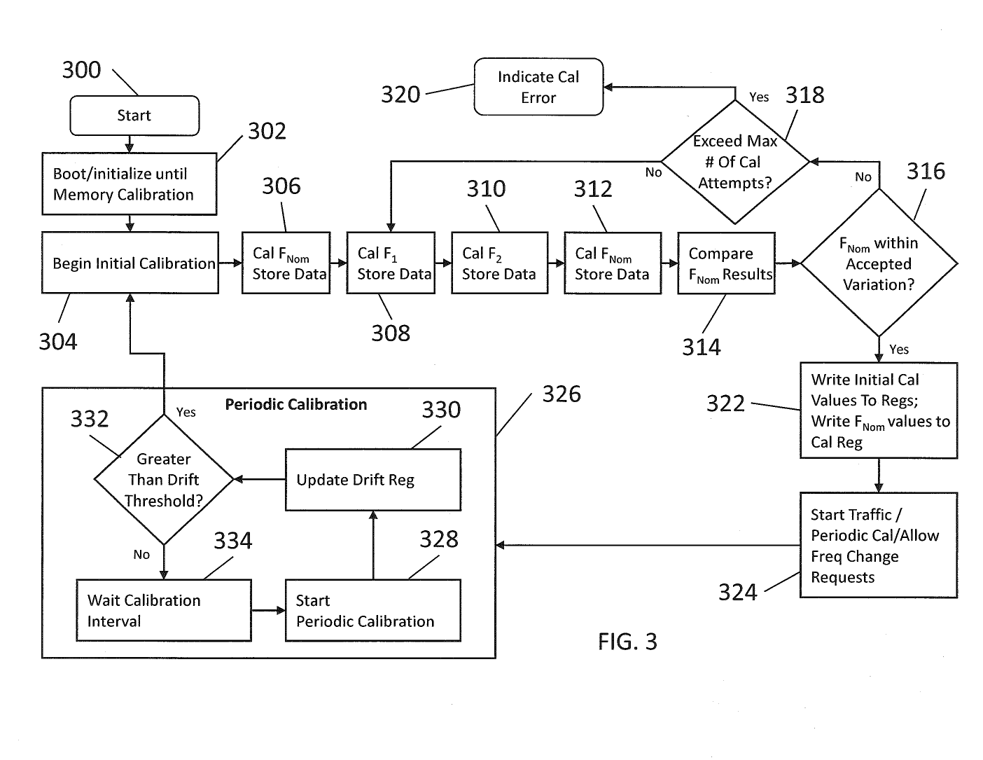

FIG. 3 is a block diagram of an exemplary process for calibrating a memory system, such as the memory system 100 of FIG. 1 including the memory controller 102 coupled via one or more memory bus 106 to one or more memory device 104. The exemplary blocks may be included as part of a memory operation and calibration procedure, such as the block 214 shown in the memory operation of FIG. 2. In an embodiment, the procedure calibrates communication of signals to the memory device 104, where the signals are communicated via a suitable path such as memory bus 106. In block 300, the system is powered up. In block 302, the system boots or initializes until the memory calibration process begins. In block 304, an initial calibration process begins. In an embodiment, the memory bus 106 is quiesced and traffic to the memory device 104 is stopped. In block 306, initial calibration of the memory device 104 at a nominal frequency (Fₙₒₘ) is performed and the calibration data is stored in the memory controller 102 and/or memory device 104. Memory device 104 calibrations may include taking multiple measurements at the selected frequency to provide an average, thus accounting for any slight variations during the process. In block 308, initial calibration of the memory device 104 at a first alternate frequency (F₁) is performed and the calibration data is stored in the memory controller 102 and/or memory device 104. In block 310, initial calibration of the memory device 104 at a second alternate frequency (F₂) is performed and the calibration data is stored in the memory controller 102 and/or memory device 104. In block 312, initial calibration of the memory device 104 at the nominal frequency (Fₙₒₘ) is performed again and the calibration data or values are stored in the memory controller 102 and/or memory device 104.

In block 314, the results for nominal frequency initial calibration in blocks 306 and 312 are compared to determine a variation in the calibration results, where a larger variation indicates system and/or environmental instability. In block 316, the system determines if the variation between for the two nominal frequency initial calibrations is acceptable. In an embodiment, if the second calibration from block 312 does deviate from the first calibration from block 306 by more than a selected number of clock cycles (i.e., threshold value), then the variation is not acceptable and the process proceeds to block 318. The variation in clock cycles may be calculated in fractions of a clock. For example, about five percent of the number of clock steps may be acceptable in an example. In block 318, a check is performed that the number of initial calibration attempts has not exceeded a threshold. If the threshold is exceeded, a calibration error is indicated in block 320. Further, a timeout may be implemented in the block to prevent an infinite loop of initial calibrations. If the threshold for the number of calibrations is not exceeded, the process proceeds to block 308 again for another initial calibration attempt. Returning to block 316, in an embodiment, if the second calibration in block 312 data does not deviate from the first calibration in block 306 data by more than a selected number of delay offsets, then the variation is acceptable. In an embodiment, an acceptable variation is about 5 percent of the number of clock steps. After a determination that the variation is acceptable, the initial calibration values for each frequency are saved in initial data registers in block 322, thereby enabling communication to the memory device 104 to begin. Block 322 also includes copying the initial calibration values for the nominal frequency (i.e., initial operating frequency) to calibration data registers in the memory controller 102 to enable memory device 104 operation at the nominal frequency. In embodiments, initial calibration is performed at a plurality of frequencies ranging from two to 50 operating frequencies for the memory device 104. Examples of operating frequencies include 800 MHz, 1066 MHz and 1333 MHz. In an embodiment, calibration values for the operating frequencies are broken into two values to conserve memory usage, where the first value is a coarse or base value shared by all frequencies and the second value is a fine value that indicates the offset from the base value for each frequency. Further, if the initial calibration values for different operating frequencies are the same, a single set of registers may be used to store initial calibration data for the frequencies, thus saving memory usage.

In block 324, traffic to the memory device 104 begins at the nominal frequency while periodic calibrations are performed to maintain system accuracy. In addition, the memory controller 102 is available to receive frequency change requests in the block 324. Periodic calibrations may be performed based on a suitable parameter, such as at a selected time interval for the system, an interval between uses and an interval between calibration of each operating frequency. Block 326 depicts an example of periodic calibration that occurs at a selected time interval for the system. The periodic calibration accounts for small changes or drift due to various sources, such as voltage, frequency or temperature drift. In embodiments, the drift calibration value is provided in units that are frequency independent, such as time (i.e., picoseconds). In block 328, the periodic calibration process is started, where a short calibration is performed to determine one or more drift calibration values. In block 330, the drift calibration value is stored in a drift register in the memory controller 102 or memory device 104. In block 332, the drift calibration value is compared to a threshold value. The threshold value may be constrained by the limited amount of bits allocated to storing the drift calibration value. If the drift calibration value is greater than the threshold, then the variation from the initial calibration value is too great and the initial calibration process begins in block 304 while the drift calibration value is reset to zero. In block 334, if the drift calibration value is not greater than the threshold, the memory system 100 continues operating and waits the selected calibration interval to perform the next periodic calibration. In an embodiment, the periodic calibration process for determining the drift calibration value is relatively short in duration as compared to the longer initial calibration process (blocks 304-316), thus provides a small drift compensation to combine with the initial calibration value for the current operating frequency to provide accuracy and improved performance. By performing the shorter periodic calibration, the traffic stoppage for the relatively longer initial calibration is also avoided, further improving the user experience and performance. In an embodiment, the short calibration takes about 32 or 64 clock cycles to complete and a long calibration takes about 250 or more clock cycles to complete.

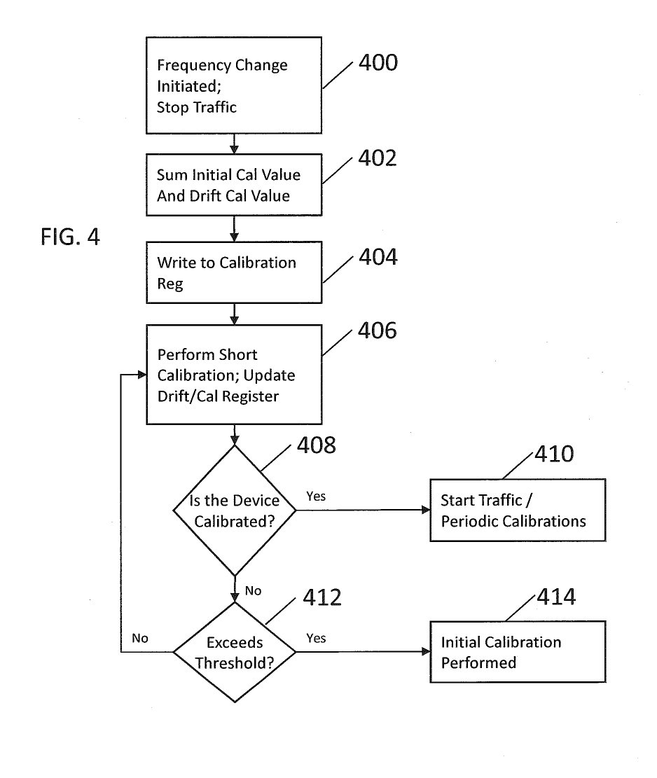

FIG. 4 is a diagram of an exemplary process for calibrating the memory system 100 as part of a frequency change process for the system. In block 400, a frequency change request is received then initiated, where traffic to the memory device 104 is stopped. The request is a change from a first supported operating frequency to a new operating frequency, where both frequencies are operating frequencies calibrated during initial calibration. In block 402, the initial calibration value for the requested new frequency is added to the current drift calibration value stored in the drift register. In block 404, the combined value is written to the calibration register. In an embodiment, the calibration register is in the memory controller 102 or a buffer within the controller. In block 406, a short calibration is performed on the memory device 104. In one embodiment, the short calibration is a coarse calibration that provides an adjustment to timing of less than about one clock cycle for the new frequency. In block 408, the memory controller 102 checks if the memory device 104 is properly calibrated by performing a short calibration, such as a drift value determination. In an embodiment, if the calibration value from the short calibration is different from the calibration register value, then the calibration register is updated with the result of the short calibration and the current drift value is also updated. In an embodiment, the short calibration verifies that the value written to the calibration register in block 404 is correct, and that the calibration value is acceptable or within industry standard specifications. If the calibration is not acceptable, block 412 determines if the difference between the calibration register and the short calibration exceeds a threshold, where the short calibration routine is performed again in block 406 if the difference is less than the threshold. In an embodiment, if the short calibration repeats multiple times and remains uncalibrated and less than the threshold, the memory controller has a timeout to prevent an infinite loop. In block 410, if the calibration is determined as acceptable in block 408, traffic to the memory device 104 is resumed, where periodic calibrations, such as the routine in block 326, are performed. In block 414, if the calibration is not acceptable and exceeds the selected threshold, the initial calibration process is performed again. The depicted process enables a dynamic frequency change for the memory device 104 without powering down the device or an extended time period with traffic blocked. Accordingly, the user experience and performance are improved by providing a dynamic process for changing memory device frequency between supported frequencies, where the frequency may be adjusted to conserve power during periods of reduced activity.

In embodiments, the blocks shown in FIGS. 3 and 4 may be performed by the memory controller 102, thereby providing support for dynamic frequency change on the controller or host portion of the system. In an embodiment, the initial calibration process is performed for a plurality of operating frequencies during boot up after the memory system is powered up, where the initial calibration values for each frequency are stored for later use. The initial calibration process includes a check to ensure that the environment is stable. The memory device is then operated at a nominal frequency (one of the operating frequencies), where the initial calibration value for the nominal frequency is corrected over time using a periodic calibration that provides small adjustments to compensate for changes in bus/clock/timing performance. The periodic calibration provides a frequency independent adjustment that may be applied to initial calibration values for a new operating frequency after a frequency change request is received. Accordingly, the calibration process provides flexibility for frequency changes for the memory device without powering down, thus improving performance.

In another embodiment, the initial calibration values for each of the supported or operating frequencies are updated periodically based on a selected interval. The selected interval may be a substantially long period of time, as performing the initial calibration process can cause significant delays while traffic to the memory device is stopped. Further, in one embodiment, after a frequency change is requested, a timer may be checked to see the time period since an initial calibration for the new frequency. If the time period exceeds a threshold, the memory controller begins the initial calibration process for each operating frequency to provide updated calibration values. If the time period is less than a threshold, the memory controller allows the change of frequency and combines the initial calibration value for the new frequency with the current drift calibration value. Accordingly, with the combined initial calibration and drift calibration values, a short calibration provides a coarse adjustment that is typically sufficient for accurate communication to the memory device. If the short calibration result is greater than a threshold, the initial calibration process is performed to provide accurate calibration values. Similarly, in an embodiment, a selected number of drift calibrations are allowed before the initial calibration is required following a frequency change request. Accordingly, a counter keeps track of the number of periodic calibrations performed, where when a frequency change is requested after the number exceeds a threshold, the initial calibration process is performed for each operating frequency.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for operating a memory system, the method comprising:
storing initial calibration values for each of a first frequency and second frequency for a memory device;
performing a periodic calibration to determine a calibration update value for operation of the memory device at the first frequency;
combining the calibration update value with the initial calibration value for the first frequency to provide an updated calibration for operation of the memory device at an operating frequency of the first frequency;
receiving a frequency change request at a memory controller associated with the memory device;
blocking traffic to the memory device;
adjusting the operating frequency from the first frequency to the second frequency, wherein the operating frequency is adjusted while the memory device remains powered;
combining the calibration update value with the initial calibration value for the second frequency for operation at the second frequency; and
enabling traffic to the memory device.

2. The method of claim 1, further comprising updating frequency-dependent parameters based on the second frequency after the operating frequency is adjusted, and wherein blocking traffic to the memory device comprises sending a self-timed refresh command to the memory device.

3. The method of claim 1, further comprising performing a second initial calibration based on a selected interval to determine and store new initial calibration values for the first frequency and the second frequency.

4. The method of claim 1, wherein storing initial calibration values for the first frequency and the second frequency for the memory device comprises storing initial calibration values for the first frequency, the second frequency and a third frequency for the memory devices, wherein the first frequency, the second frequency and the third frequency are each operating frequencies for the memory device.

5. The method of claim 1, wherein storing initial calibration values for the first frequency and second frequency for the memory device comprises determining initial calibration values for the first frequency twice and for the second frequency once, wherein the initial calibration values for the first frequency are checked to determine if they are within an acceptable variation value to ensure environmental stability.

6. The method of claim 5, wherein operation at the first frequency is enabled by writing the initial calibration values for the first frequency to a calibration register based a determination that the initial calibration values are within the acceptable variation value.

7. The method of claim 1, wherein performing the periodic calibration to determine the calibration update value comprises determining a drift change in calibration and wherein the periodic calibration is performed at a selected calibration interval.

8. The method of claim 7, wherein performing the periodic calibration to determine the calibration update value comprises comparing the calibration update value to a threshold, where a second initial calibration is started responsive to the calibration update value being greater than the threshold.

9. A computer program product for operating a memory system, the computer program product comprising:
a tangible storage medium readable by a processing circuit and storing instructions for execution by the processing circuit for performing a method comprising:
storing initial calibration values for each of a first frequency and second frequency for a memory device;
performing a periodic calibration to determine a calibration update value for operation of the memory device at the first frequency;
combining the calibration update value with the initial calibration value for the first frequency to provide an updated calibration for operation of the memory device at an operating frequency of the first frequency;
receiving a frequency change request at a memory controller associated with the memory device;
blocking traffic to the memory device;
adjusting the operating frequency from the first frequency to the second frequency, wherein the operating frequency is adjusted while the memory device remains powered;
combining the calibration update value with the initial calibration value for the second frequency for operation at the second frequency; and
enabling traffic to the memory device.

10. The computer program product of claim 9, wherein the method further comprises updating frequency-dependent parameters based on the second frequency after the operating frequency is adjusted, and wherein blocking traffic to the memory device comprises sending a self-timed refresh command to the memory device.

11. The computer program product of claim 9, wherein the method further comprises performing a second initial calibration based on a selected interval to determine and store new initial calibration values for the first frequency and the second frequency.

12. The computer program product of claim 9, wherein storing initial calibration values for the first frequency and the second frequency for the memory device comprises storing initial calibration values for the first frequency, the second frequency and a third frequency for the memory devices, wherein the first frequency, the second frequency and the third frequency are each operating frequencies for the memory device.

13. The computer program product of claim 9, wherein storing initial calibration values for the first frequency and second frequency for the memory device comprises determining initial calibration values for the first frequency twice and for the second frequency once, wherein the initial calibration values for the first frequency are checked to determine if they are within an acceptable variation value to ensure environmental stability.

14. The computer program product of claim 13, wherein operation at the first frequency is enabled by writing the initial calibration values for the first frequency to a calibration register based a determination that the initial calibration values are within the acceptable variation value.

15. The computer program product of claim 9, wherein performing the periodic calibration to determine the calibration update value comprises determining a drift change in calibration and wherein the periodic calibration is performed at a selected calibration interval.

16. A system for operating a memory system, the system comprising:
a memory controller and a memory device, the system configured to perform a method comprising:
storing initial calibration values for each of a first frequency and second frequency for a memory device;
performing a periodic calibration to determine a calibration update value for operation of the memory device at the first frequency;
combining the calibration update value with the initial calibration value for the first frequency to provide an updated calibration for operation of the memory device at an operating frequency of the first frequency;
receiving a frequency change request at a memory controller associated with the memory device;
blocking traffic to the memory device;
adjusting the operating frequency from the first frequency to the second frequency, wherein the operating frequency is adjusted while the memory device remains powered;
combining the calibration update value with the initial calibration value for the second frequency for operation at the second frequency; and
enabling traffic to the memory device.

17. The system of claim 16, wherein the method further comprises updating frequency-dependent parameters based on the second frequency after the operating frequency is adjusted, and wherein blocking traffic to the memory device comprises sending a self-timed refresh command to the memory device.

18. The system of claim 16, wherein storing initial calibration values for the first frequency and second frequency for the memory device comprises storing initial calibration values for the first frequency, the second frequency and a third frequency for the memory devices, wherein the first frequency, the second frequency and the third frequency are each operating frequencies for the memory device.

19. The system of claim 16, wherein storing initial calibration values for the first frequency and the second frequency for the memory device comprises determining initial calibration values for the first frequency twice and for the second frequency once, wherein the initial calibration values for the first frequency are checked to determine if they are within an acceptable variation value to ensure environmental stability, and wherein operation at the first frequency is enabled by writing the initial calibration values for the first frequency to a calibration register based a determination that the initial calibration values are within the acceptable variation value.

20. The system of claim 16, wherein performing the periodic calibration to determine the calibration update value comprises determining a drift change in calibration and wherein the periodic calibration is performed at a selected calibration interval.
